(19) United States
(12) Patent Application Publication
(10) Pub. No.: US 2006/0003848 A1
(43) Pub. Date: Jan. 5, 2006

(54) Sliding type constant velocity universal joint

(76) Inventors: Akira Sonoda, Iwata-shi (JP); Tadashi Suzuki, Iwata-shi (JP); Shuji Mochinaga, Iwata-shi (JP); Kentaro Terada, Iwata-shi (JP)

Correspondence Address: J C PATENTS, INC., 4 VENTURE, SUITE 250, IRVINE, CA, 92618, US

(21) Appl. No.: 11/173,801

(22) Filed: Jun. 30, 2005

(30) Foreign Application Priority Data
Jul. 1, 2004 (JP) 2004-195766

(51) Int. Cl. F16D 3/26

(52) U.S. Cl. 464/111

(57) ABSTRACT

A sliding type constant velocity universal joint is provided that can prevent a pressure buildup inside the joint when fitting a boot adapter to an outer joint member. The outer joint member has a seal portion in an outer surface on the far end side of a portion that mates with a fitting portion of the boot adaptor. The seal portion is fitted with the fitting portion in an airtight manner. A small diameter portion having a smaller diameter than the seal portion is provided in a region nearer to an open end of the outer joint member than the seal portion to form a gap between the small diameter portion of the outer joint member and the fitting portion of the boot adaptor.

### BACKGROUND OF THE INVENTION

1. Field of the Invention

The present invention relates to sliding type constant velocity universal joints for transmitting torque between input and output shafts while accommodating angular and axial displacements therebetween, and more particularly to such constant velocity universal joints having boots for preventing entrance of contaminants and lubricant leakage.

2. Description of the Related Art

A conventional tripod type constant velocity universal joint, which is one type of a sliding type constant velocity universal joint, is described below with reference to FIG. 5 and FIG. 6. As shown, the tripod type constant velocity universal joint includes an outer joint member 10, an inner joint member 20, and roller assemblies 30, as main components. The outer joint member 10 has a cylindrical inner surface 11 including three linear track grooves 12 extending in an axial direction, and roller guide surfaces 13 formed on both circumferential sides of each linear track groove 12. The inner joint member 20 has a tripod member 22 with three radially projecting trunnions. The tripod member 22 is inserted in the outer joint member 10 and a shaft 23 extends from the tripod member 22 to the outside of the outer joint member 10. The roller assemblies 30 have rollers 31 inserted in the linear track grooves 12 of the outer joint member 10 and are rotatably fitted to the trunnions 21 of the tripod member 22 with needle bearings 32 therebetween.

When torque is applied to the tripod type constant velocity universal joint configured as above with an angular displacement between the outer joint member 10 and the inner joint member 20, the roller assemblies 30 slide back and forth along the roller guide surfaces 13 of the outer joint member 10 as the inner joint member 20 rotates. Any contaminants present between the roller guide surfaces 13 and rollers 31 cause friction resistance therebetween and may inhibit the torque transmission between the outer joint member 10 and the inner joint member 20. In some tripod type joints inside of which is filled with lubricant, lubricant leakage from the inside of the joint will lead to lubrication failure and may inhibit the torque transmission between the outer joint member 10 and the inner joint member 20. To prevent such entrance of contaminants and lubricant leakage, the above described tripod type constant velocity universal joint is generally provided with a boot 40 for sealing the inside of the joint.

As shown in FIG. 5, the boot 40 has a boot body 41 made of resilient material such as rubber or plastic, and a boot adaptor 42 that connects the boot body 41 with the outer joint member 10. The boot body 41 has a substantially U-shape cross section and an annular shape, and its inner peripheral edge 43 is tightened to the shaft 23 of the inner joint member 20 using a boot band 44. The boot adaptor 42 is generally cylindrical, having one end crimped to the outer peripheral edge 45 of the boot body 41. As shown in the enlarged view of FIG. 5, the other end of the cylindrical boot adaptor 42 has a fitting portion 46 and a swaged portion 47 extending from the fitting portion 46. The fitting portion 46 is hermetically fitted to a seal portion 14 of the outer joint member 10. The swaged portion 47 is swaged radially inwardly to engage with a corresponding portion 15 of the outer joint member 10.

The outer joint member 10 further includes an annular groove 16 formed in the seal portion 14 as shown in the enlarged view of FIG. 5. An O-ring 17 made of resilient material such as rubber or plastic is mounted in the groove 16 to enhance the seal between the outer joint member 10 and the boot adaptor 42.

While the boot mounting design of the above-described conventional example is that of tripod type constant velocity universal joints, Japanese Patent Laid-Open Publication No. 2003-056590 shows a substantially identical boot mounting design for cross-groove type constant velocity universal joints, which are another type of sliding type constant velocity universal joints. A cross-groove type constant velocity universal joint typically includes an outer joint member having a cylindrical inner surface formed with a plurality of linear track grooves, an inner joint member having a spherical outer surface formed with a plurality of linear track grooves opposite the linear track grooves of the outer joint member, a plurality of balls interposed in the track groove cross section between the outer joint member and the inner joint member, and a retainer accommodated in an annular spacing between the outer joint member and the inner joint member for retaining the balls.

When assembling this conventional sliding type constant velocity universal joint, the tripod member 22 and roller assemblies 30 (or inner race and balls in the case with the cross-groove joint) are assembled to the outer joint member 10, and the shaft 23 with the boot body 41 fitted thereon is press-fitted into the tripod member 22 (or inner race in the case with the cross-groove joint), while the boot adaptor 42 is press-fitted onto the seal portion 14 of the outer joint member 10. As the inside of the joint is sealed by the fitting portion 46 of the boot adaptor 42 rubbing against the seal portion 14 of the outer joint member 10, when the boot adaptor 42 is press-fitted from the open end to the fitting end of the outer joint member 10, the air inside the joint is compressed and the inside pressure builds up. This pressure buildup causes deformation of the boot body 41 so as to render the cross section of which in a generally C-shape as indicated by broken lines in FIG. 5. Relative axial movement of the outer joint member 10 and inner joint member 20 and torque application to the outer and inner joint members 10 and 20 with angular displacement therebetween bend or reverse the boot body 41 leading the boot body to rub against the shaft 23 and resulting in the boot body 41 getting wear or cracks, because of which the durability of the boot body 41 is reduced.

It has been the practice to reduce the pressure inside the joint by creating a gap in the mating parts between the boot body 41 and the shaft 23 using a tool to release the air inside the joint so that the boot body 41 returns to its original shape. While such depressurization prevents wear of the boot body 41 and increases the life of the same, there is the danger that the tool may damage the boot body 41 or the shaft 23 leading to the gas tight deterioration of the joint.

### SUMMARY OF THE INVENTION

Based on the foregoing, an object of the present invention is to provide a sliding type constant velocity universal joint which can be assembled without causing an inside pressure buildup so that the durability of the boot body is improved.

To achieve the object, the invention provides a sliding type constant velocity universal joint for transmitting torque between an outer joint member and an inner joint member fitted in the outer joint member while accommodating angular and axial displacements therebetween, including a boot having a boot body made of resilient material and a boot adaptor attached to one end of the boot body. The boot adaptor is fitted onto the outer surface of the outer joint member while the boot body is fitted onto a shaft extending from the inner joint member to the outside of the outer joint member to seal the inside of the joint. The outer joint member is provided with a seal portion in the outer surface on the far end side of a portion that mates with a fitting portion of the boot adaptor. The fitting portion of the boot adaptor is fitted to the seal portion in an airtight manner. The outer joint member further includes a small diameter portion having a smaller diameter in a region nearer to the open end than the seal portion the diameter of which is smaller than that of the seal portion, so that a gap is formed between the small diameter portion of the outer joint member and the fitting portion of the boot adaptor.

Because of the small diameter portion having a smaller diameter than the outside diameter of the seal portion, a gap is formed between the small diameter portion of the outer joint member and the fitting portion of the boot adaptor. This gap allows communication between inside and outside of the joint until the boot adaptor is completely fitted with the seal portion of the outer joint member and prevents a pressure buildup inside the joint. That is, if the mating parts between the outer joint member and the boot adaptor have the same length as that of conventional joints, the air inside the joint in the portion between the fitting portion of the boot adaptor and the small diameter portion of the outer joint member is not compressed. Deformation of the boot body when fitting the boot adaptor to the outer joint member is thus suppressed.

As discussed above, according to the sliding type constant velocity universal joint of the present invention, because of the small diameter portion having a smaller diameter than the outside diameter of the seal portion in a region nearer to the open end than the seal portion, a gap is formed between the small diameter portion of the outer joint member and the fitting portion of the boot adaptor. Therefore, the air inside the joint in the portion between the fitting portion of the boot adaptor and the small diameter portion of the outer joint member is not compressed, and deformation of the boot body caused by a pressure buildup inside the joint is suppressed. Thus, wear of the boot body due to its rubbing against the shaft of the inner joint member is prevented, and the durability of the boot body is improved.

### BRIEF DESCRIPTION OF THE DRAWINGS

In the accompanying drawings:

FIG. 1 is a cross-sectional view of one embodiment of a tripod type constant velocity universal joint, which is one type of a sliding type constant velocity universal joint, of the present invention, part of which is enlarged to a greater scale;

FIG. 2 is a diagram for explaining how a boot adapter is assembled to an outer joint member;

FIG. 3 is an enlarged cross-sectional view illustrating relevant part of a modified example of the sliding type constant velocity universal joint of the invention;

FIG. 4 is an enlarged cross-sectional view illustrating relevant part of a modified example of the sliding type constant velocity universal joint of the invention;

FIG. 5 is an axial cross-sectional view of a conventional sliding type constant velocity universal joint; and

FIG. 6 is a cross-section view in a direction orthogonal to the axis of the conventional sliding type constant velocity universal joint.

### DETAILED DESCRIPTION OF THE PREFERRED EMBODIMENTS

Preferred embodiments of the present invention will be hereinafter described with reference to the accompanying drawings.

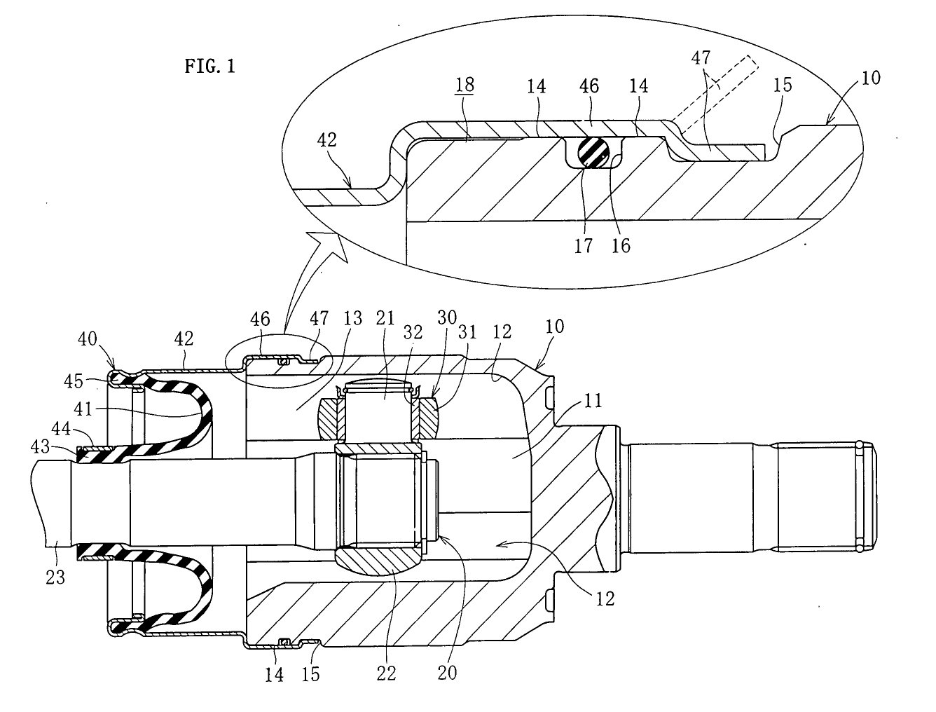

FIG. 1 is a cross-sectional view of one embodiment of a tripod type constant velocity universal joint, which is one type of a sliding type constant velocity universal joint, of the present invention. The tripod type constant velocity universal joint of FIG. 1 generally includes, as the main components, an outer joint member 10, an inner joint member 20, and roller assemblies 30 as with the conventional example described in the foregoing. A boot 40 is fitted to an outer peripheral edge of the outer joint member 10 and to the shaft 23 of the inner joint member 20 to seal the inside of the joint. Since the inner joint member 20, the roller assemblies 30, and the boot 40 are the same as the conventional example, these are given the same reference numerals and detailed description thereof is omitted. The outer joint member 10, which has the characteristic feature of the invention, will be described below.

The outer joint member 10 includes a seal portion 14 on the far end side of a portion that mates with a fitting portion 46 of the boot adaptor 42. The seal portion 14 is fitted with the fitting portion 46 of the boot adaptor 42 in an air tight manner. A step is formed in a region nearer to the open end than the seal portion 14 where the diameter is smaller than that of the seal portion 14 to define a small diameter portion 18. The seal portion 14 has a diameter that is generally the same as the inside diameter of the fitting portion 46 of the cylindrical boot adaptor 42 so that it is air-tightly fitted with the fitting portion 46 of the boot adaptor 42. The small diameter portion 18 has a slightly smaller diameter than the inside diameter of the fitting portion 46 of the boot adaptor 42 to define an air passage gap between itself and the fitting portion 46 as well as to reduce rattling of the boot adaptor 42 due to the loose fitness thereof.

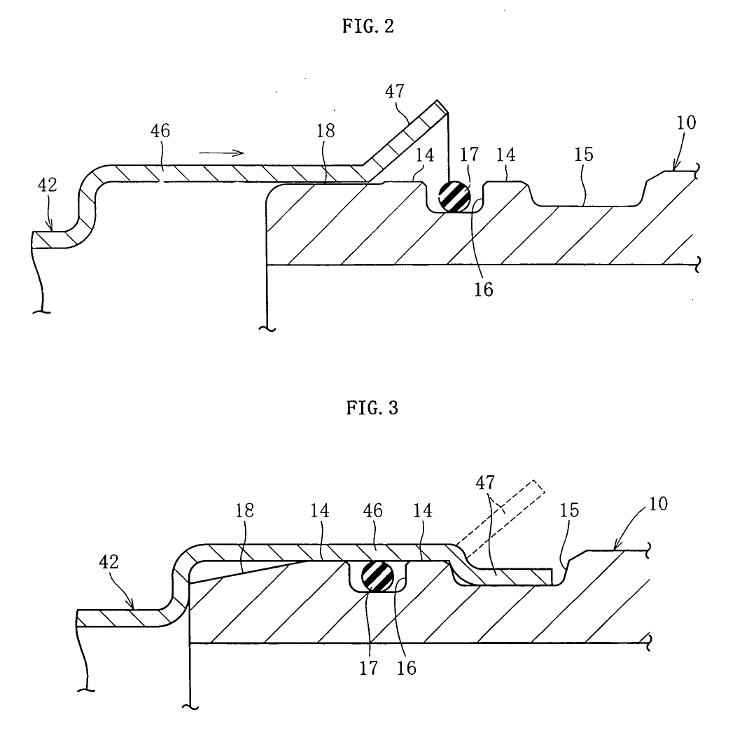

When the fitting portion 46 of the boot adaptor 42 is fitted to the open end of the outer joint member 10, this small gap between the small diameter portion 18 of the outer joint member 10 and the fitting portion 46 of the boot adaptor 42 allows communication between inside and outside of the joint until the fitting portion 46 reaches the seal portion 14, as shown in FIG. 2, thereby preventing a pressure buildup inside the joint. That is, when the boot adaptor 42 is completely fitted to the fitting end of the outer joint member 10, the air inside the joint in the portion between the fitting portion 46 of the boot adaptor 42 and the small diameter portion 18 of the outer joint member 10 has not been compressed. Deformation of the boot body 41 due to pressure buildup inside the joint is thus suppressed. As the boot body 41 is thereby prevented from wear due to rubbing against the shaft 23 of the inner joint member 20, improved durability of the boot body 41 is obtained.

The boot adaptor 42 is not incurred with press-fitting load until it comes to the seal portion 14 of the outer joint member 10. As reduced is the accumulated load on the boot adaptor 42 when it is fitted to the outer joint member 10, the strength of the boot adaptor 42 against the press-fitting load can be decreased without incurring any danger of damage to the boot adaptor 42 when it is fitted to the outer joint member 10. Accordingly, the boot adaptor 42 can be made thinner and lighter.

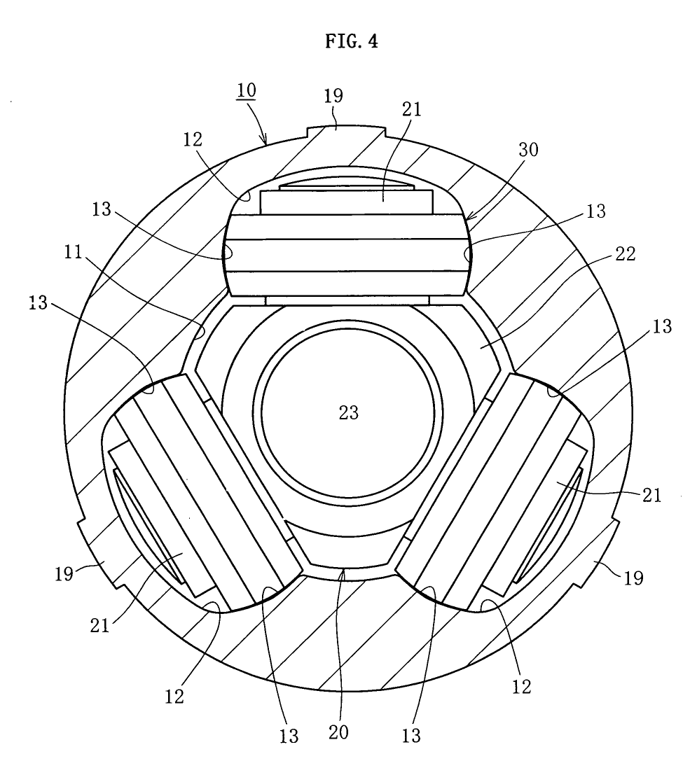

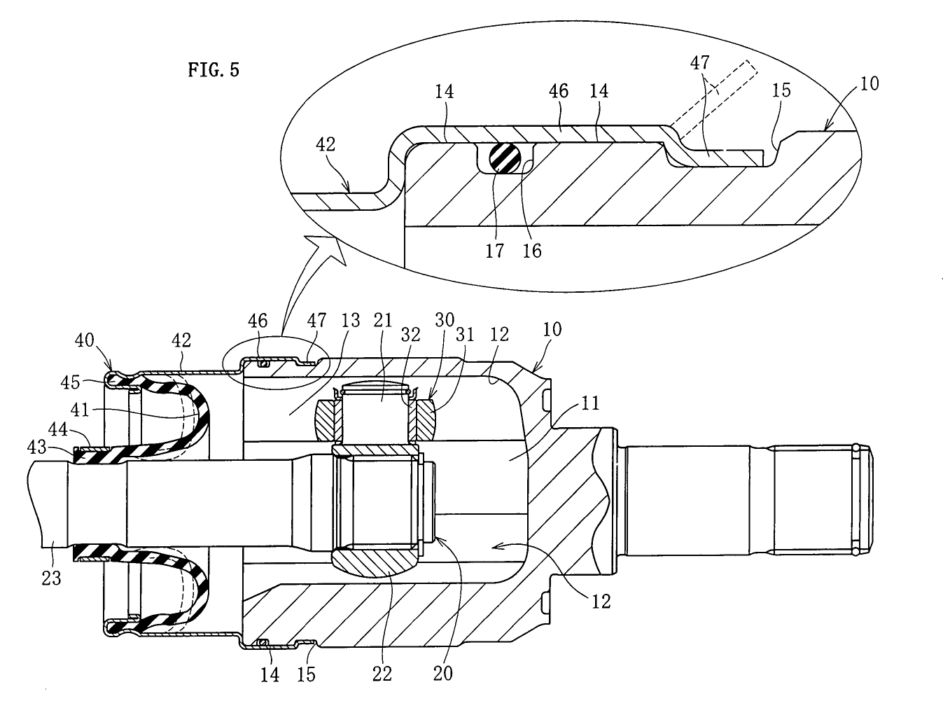

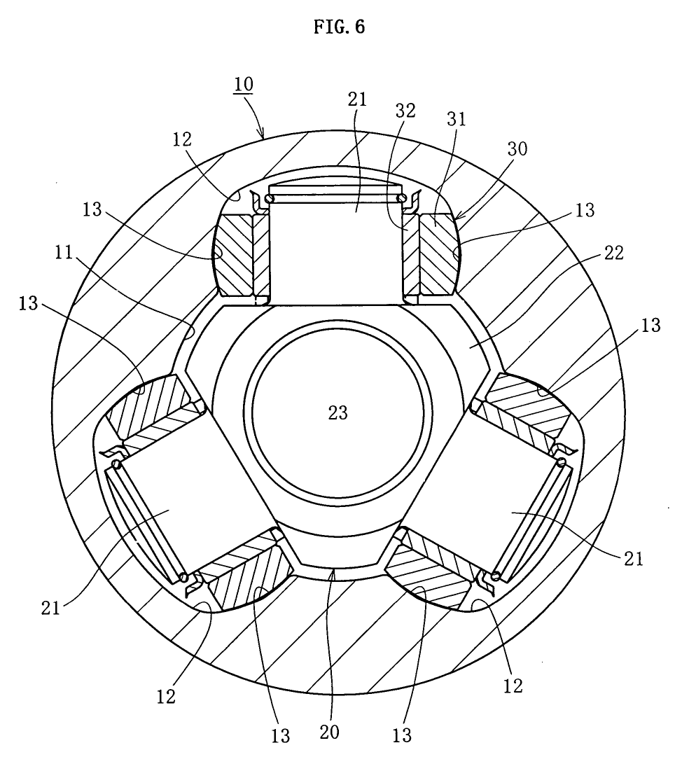

While the invention has been described in the form of a preferred embodiment, the invention is not limited to the form described, and numerous modifications may be made to the above-described embodiment. For example, while the small diameter portion 18 of the outer joint member 10 is formed as a stepped surface having a smaller diameter than the seal portion 14, the small diameter portion 18 may be tapered as shown in FIG. 3, or may have any other shape as long as it has a smaller diameter than the seal portion 14.

In the above-described embodiment, the small diameter portion 18 of the outer joint member 10 has a slightly smaller diameter than the outside diameter of the seal portion 14 for the purpose of reducing rattling of the fitting portion 46 of the boot adaptor 42 due to the loose fitness thereof. Alternatively, a plurality of ribs 19 may be provided on the small diameter portion 18 as shown in FIG. 4. As such ribs accommodate the fitting looseness, the diameter of the small diameter portion 18 can be further reduced. The ribs 19 may extend longitudinally to make line contact with the boot adaptor 42, or they may be pins to make point contact with the boot adaptor 42.

While the sliding type constant velocity universal joint of the invention has been described as a tripod type constant velocity universal joint having single roller type roller assemblies 30, the invention may be applied to a tripod type constant velocity universal joint having double roller type roller assemblies, or to other types of sliding type constant velocity universal joints such as cross-groove joints.

What is claimed is:

1. A sliding type constant velocity universal joint for transmitting torque between an outer joint member and an inner joint member fitted in the outer joint member while accommodating angular and axial displacements therebetween, including a boot having a boot body made of resilient material and a boot adaptor attached to one end of the boot body, the boot adaptor being fitted onto the outer surface of the outer joint member while the boot body is fitted to a shaft extending from the inner joint member to the outside of the outer joint member to seal the inside of the joint, wherein:
the outer joint member is provided with a seal portion in the outer surface on the far end side of a portion that mates with a fitting portion of the boot adaptor, the fitting portion of the boot adaptor being fitted to the seal portion in an airtight manner; and
the outer joint member includes a small diameter portion in a region nearer to the open end than the seal portion having a smaller diameter than the outside diameter of the seal portion, so that a gap is formed between the small diameter portion of the outer joint member and the fitting portion of the boot adaptor.

2. A sliding type constant velocity universal joint according to claim 1, the small diameter portion of the outer joint member is tapered.

3. A sliding type constant velocity universal joint according to claim 1, the small diameter portion is provieded with a plurality of ribs.
